(19) United States
(12) Patent Application Publication
(10) Pub. No.: US 2004/0024112 A1
(43) Pub. Date: Feb. 5, 2004

(54) Stable aqueous polymer emulsions, production and use thereof

(76) Inventors: Gunther Glas, Meckenheim (DE); Toni Simenc, Mannheim (DE)

Correspondence Address: KEIL & WEINKAUF, 1350 CONNECTICUT AVENUE, N.W., WASHINGTON, DC, 20036, US

(21) Appl. No.: 10/239,408

(22) PCT Filed: Mar. 26, 2001
(86) PCT No.: PCT/EP01/03406

(51) Int. Cl. C08J 3/00

(52) U.S. Cl. 524/588

(57) ABSTRACT

Stable aqueous polymer emulsions comprising the components A to C, water and, if required, further assistant and additives,

component C comprising polyolefin oxidation products which have in particular carboxyl and ester groups,

component D comprising aminofunctional polyorganosiloxanes and

component E comprising nonionic emulsifiers, are described.

The polymer emulsions preferably additionally contain condensates of fatty acids with from 5 to 150 mol %, per mole of fatty acid, of amino alcohols and with from 5 to 200 mol %, per mole of fatty acid, of polyols (component D) and at least partially quaternized condensates of fatty acids with from 0.35 to 3.5 mol, per mole of fatty acid, of tertiary amino alcohols quaternized with quaternizing agents of the formula X-R¹⁴, where X is a radical which can be eliminated as an anion and R¹⁴ is a lower alkyl radical.

A process for the advantageous preparation of the novel polymer emulsions and their use as assistants in permanent textile finishing, in particular as softeners and smoothing agents and for improving sewability, are furthermore described.

The present invention relates to aqueous polymer emulsions, which contain polyolefin or paraffin oxidation products and aminopolyorganosiloxanes as well as emulsifiers and, if required, esters having basic nitrogen groups, processes for the advantageous preparation of the novel polymer emulsions and their use as assistants in permanent textile finishing, in particular as softeners, as smoothing agents and for improving the sewability.

Modern textile operations are constantly striving to increase productivity through the use of modem, extremely high-speed production machines. At the same time, care must be taken to ensure that fabric quality is maintained or ideally improved despite the higher production speed. For example, textile finishing processes involving pad-mangling are run at pad-mangle or tenter speeds of up to 150 m/min. This imposes extremely high demands on the properties of the finishes and assistants used, which are usually employed in the form of emulsions. These emulsions have to be extremely stable to shearing in order to withstand the enormous shearing forces of the high-speed pad-mangle bowls and fabric webs for prolonged periods.

Similar problems arise in the search for increased productivity in the making-up of textile materials. Industrial sewing machines which operate at up to 7 000 stitches/min are used here. Such machines set very high requirements with regard to the sewability of the textiles to be made up. Without specific sewability-improving assistants, sewing needles may damage threads at loops, causing small fabric defects which can develop into larger holes in later use or in domestic laundry.

There was therefore an urgent need for textile assistants having a very broad performance profile, enabling ideally universal use in modern production facilities.

DE-A-196 26 317 discloses condensates of amino-containing alcohols and of polyols with fatty acids which can be used for reducing yellowing in the storage of dyed textiles and as softeners for the low-yellowing permanent finishing of textiles.

DE-A-33 43 575 discloses a process for the preparation of stable emulsions comprising a) diorganopolysiloxanes having terminal Si-bonded OH groups, b) polyorganosiloxanes having at least two substituents containing —NH— or —NH₂ groups, c) polyorganosiloxanes having at least two hydroxyl, alkoxy or acyloxy groups bonded directly or via a polyether chain to Si, and a condensation catalyst. The emulsions are said to be useful for the permanent, including drycleaning-durable, hand and elasticity improvement of textile materials.

DE-A-39 29 757 discloses emulsifier-containing aqueous emulsions of protonated aminopolysiloxanes which are said to be suitable as shear-stable hand-improving finishes for textile materials.

In several publications, for example those by Grafmüller and Husemann, “Über die Oxydation von Polyolefinen”, Makromol. Chem. 40 (1960), 161-188, various patent applications, in “Encyclopedia of Polymer Science and Technology” Vol. 6, page 499 et seq., and in “Ullmann's Encyclopedia of Industrial Chemistry”, Vol. A28, page 155 et seq., paraffin and polyolefin oxidation products which are obtained by air oxidation of paraffins or polyolefins, especially polyethylene for example, at above 100° C. are described. Because they contain carboxyl and ester groups, these products are emulsifiable and are widely used. In the textile industry, for example, the emulsions can be used for improving tensile strength and soil repellency and for imparting water repellency.

The assistants known from the prior art have each been used for relatively narrow tasks. They do not adequately meet the need for textile assistants having a very broad performance profile. This shows that it is very difficult to satisfactorily meet the requirements of such assistants, which are contradictory in some cases.

It has now been found that, surprisingly, it is possible to combine cationic silicones and anionic polyolefin oxidation products to form the stable, aqueous polymer emulsions described below, which are very useful as assistants in textile finishing and making-up processes. They impart to the finished fabric a high-quality, silk-like hand and also withstand any stresses imposed by the machinery. The novel assistants have very good shear stability on pad-mangle bowls and satisfactory running properties, considerably improve sewability and are compatible with other permanent finishing additives. They are thus capable of considerably broader use than known products.

The present invention thus relates to stable aqueous polymer emulsions comprising the components A to C, water and, if required, further assistants and additives,

component A comprising

polyolefin oxidation products comprising identical or different groups of the formula I

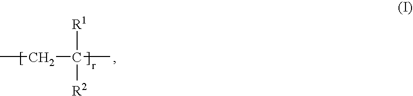

where

R¹ is hydrogen or lower alkyl,

R² is hydrogen, —COOH or another, oxygen-containing functional group and

R² is furthermore a short- or medium-chain alkyl or alkenyl group or cyclohexyl group which can also be substituted by —COOH or another, oxygen-containing functional group, or

R¹ and R² together are oxygen, and r is from 30 to 200,

component B comprising

amino-functional polyorganosiloxanes of the formula II,

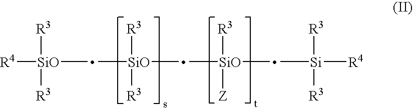

where R³ are identical or different lower alkyl or lower alkoxy groups,

R⁴ is hydroxyl or an R³ radical,

Z is an aminoalkyl radical,

s is from ˜50 to ˜300 and t is from 1 to 4, and

component C comprising

nonionic emulsifiers consisting of mixtures of alkoxylated higher alkanols.

For optimizing the performance characteristics and the preparation process as well as for further improving the emulsion stability, the novel emulsions expediently additionally contain the components D and E, component D comprising condensates of fatty acids of the formula III

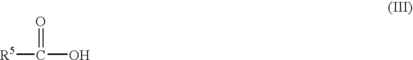

where R⁵ is a medium- to long-chain alkyl or alkenyl radical,

with from 5 to 150 mol %, per mole of fatty acid, of amino alcohols of the formula IV

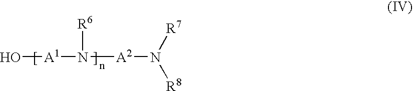

where

A¹ and A² are lower alkylene groups,

R⁶, R⁷ and R⁸ are identical or different and are each hydrogen, lower alkyl or a group -A¹—OH or -A²—OH and

n is an integer from 1 to 5, and with from 5 to 200 mol %, per mole of fatty acid, of polyols of the formula V

HO—CH₂—Y—CH₂—OH (V)

where Y is a chemical bond or a group —CR⁹R¹⁰—, where

R⁹ is hydrogen, lower alkyl or a further hydroxy-lower alkyl group and

R¹⁰ is hydrogen, lower alkyl or a further hydroxy-lower alkyl group,

and component E comprising

at least partially quaternized condensates of fatty acids of the formula VI

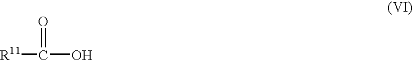

where R¹¹ is a medium- to long-chain alkyl or alkenyl radical,

with from 0.35 to 2.0 mol, per mole of fatty acid, of tertiary amino alcohols of the formula VII

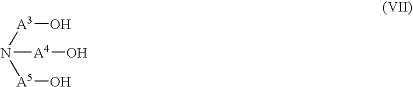

where

A³, A⁴ and A⁵ are lower alkylene groups, quaternized with quaternizing agents of the formula X-R¹², where X is a radical which can be eliminated as an anion and R¹² is a lower alkyl radical.

In addition, the emulsions can, if desired, contain further suitable additives customary for the respective application, for example fungicides, insecticides, dyes brighteners, foam suppressants and the like.

Preferred components A are

polyolefin oxidation products comprising identical or different groups of the formula I

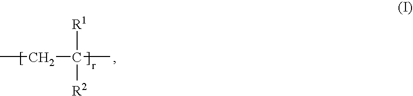

where

R¹ is hydrogen or C₁— to C₄-alkyl,

R² is hydrogen, —COOH, —CHO, —OH, lower alkylcarbonyloxy (—O—CO—R¹³) or lower alkoxycarbonyl (—COOR¹⁴), where R¹³ and R¹⁴ are alkyl radicals, preferably of 1 to 4, in particular 1 or 2, carbon atoms, and

R² is furthermore a C₁— to C₆-alkyl or alkenyl group or cyclohexyl group, which may also be substituted by —COOH, —CHO, —OH, lower alkylcarbonyloxy (—O—CO—R¹³) or lower alkoxycarbonyl (—COOR¹⁴), where R¹³ and R¹⁴ are alkyl radicals, preferably of 1 to 4, in particular 1 or 2, carbon atoms, it being possible for —COOH and —OH groups R² or —COOH and —OH groups contained in substituents R² together to form intermoleclar or intramolecular esters, or

R¹ and R² together are oxygen,

r is from 30 to 200, preferably from 40 to 100, and

the polyolefin oxidation product has an acid number of from 10 to 60, preferably from 15 to 30, mg KOH/g according to DIN 53402.

Preferred components D are

condensates of fatty acids of the formula III

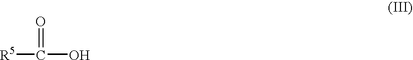

where R⁵ is a C₉— to C₂₋₁-alkyl or alkenyl radical,

with from 5 to 150 mol %, per mole of fatty acid, of amino alcohols of the formula IV

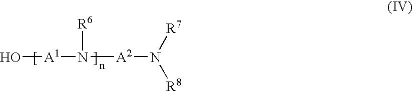

where

A¹ and A² are C₂— to C₄-alkylene groups,

R⁶, R⁷ and R⁸ are identical or different and are each hydrogen, C₁— to C₄-alkyl or a group

-A¹-OH or -A²-OH and

n is an integer from 1 to 5,

and with from 5 to 200 mol %, per mole of fatty acid, of polyols of the formula V

HO—CH₂—Y—CH₂—OH (V)

where Y is a chemical bond or a group —CR⁹R¹⁰—, where

R⁹ is hydrogen, C₁— to C₄-alkyl, or a further hydroxyalkyl group of 1 to 4 carbon atoms and

R¹⁰ is hydrogen, C₁— to C₄-alkyl or a further hydroxyalkyl group of 1 to 4 carbon atoms.

Preferred components E are

at least partially quaternized condensates of fatty acids of the formula VI

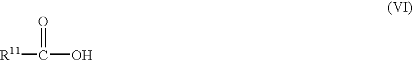

where R¹¹ is a C₉— to C₂₋₁-alkyl or alkenyl radical,

with from 0.35 to 2, preferably from 0.15 to 2, mol, per mole of fatty acid, of tertiary amino alcohols of the formula VII

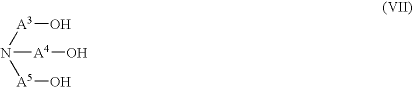

where

A³, A⁴ and A⁵ are C₂— to C₄-alkylene groups, preferably ethylene groups, quaternized with quaternizing agents of the formula X-R¹², where X is a radical which can be eliminated as an anion and R¹² is a lower alkyl radical of 1 to 4 carbon atoms.

The alkylene groups A¹ and A² contained in a compound of the formula IV may be identical or different. The same applies to the alkylene groups A³, A⁴ and A⁵ contained in a compound of the formula VII. Preferably, compounds of the formula II have two identical alkylene groups A¹ and A², and compounds of the formula VII have three identical alkylene groups A³, A⁴ and A⁵. The free bonds of the alkylene groups may be present on neighboring carbon atoms or, in the case of chain lengths greater than 2, on non-neighboring carbon atoms. Thus, a C₃-alkylene group may be a 1,2- or a 1,3-alkylene group, and a C₄-alkylene group (=butylene group) may be butane-1,2-diyl, butane-1,3-diyl, butane-1,4-diyl or butane-2,3-diyl. A butylene group may also have the structure of a 2-methylpropanediyl group.

The novel polymer emulsions may contain individual substances or a plurality of substances from each of the component groups A to E. As a rule, the materials used for the preparation of the components A to E are technical-grade products, for example natural fatty acids and amines, whose composition on analytical average corresponds to the abovementioned formulae but whose building blocks differ within the definitions stated therefor. Furthermore, to fine-tune certain performance characteristics, it may be expedient in the preparation of the novel polymer emulsions specifically to use a plurality of individual compounds from the compound classes stated for the individual components.

Preferred novel polymer emulsions comprise the components A to E, water and, if required, also further assistants and additives. They expediently contain

from 1 to 15, in particular from 2 to 10, % by weight of components A,

from 1 to 15, in particular from 2 to 10, % by weight of components B,

from 4 to 10, in particular from 5 to 8, % by weight of components C,

from 2 to 10, in particular from 4 to 8, % by weight of components D,

from 2 to 10, in particular from 4 to 8, % by weight of components E

and water and further assistants to 100% by weight.

The performance characteristics in the novel polymer emulsions do of course depend not only on the quantitative composition but of course also substantially on the structure of the components and hence also on the structure of the starting materials used, on the molar ratios used in the preparation and, as also mentioned further below, on the reaction conditions in the preparation.

The polyolefin oxidation products contained as component A in the novel polymer emulsions are functionalized polyolefins which can be illustrated by the formula I indicated above.

The polyolefin oxidation products are known substances which are prepared by known processes by air oxidation of natural paraffins or synthetic polyolefins. In this oxidation, chain cleavage and/or hydrogen elimination generally occurs, and oxygen is introduced into the alkane chains, predominantly in the form of COOH groups and OH groups. The carboxyl and hydroxyl groups react to a certain extent with one another also with formation of intermolecular and intramolecular ester groups which, if desired, can be transesterified with alkanols of short to medium chain length. This is accompanied by further complicated secondary reactions, such as isomerization and, to aminor extent, the formation of aldehyde and keto functions. By choosing starting materials and suitable reaction conditions, it is possible to obtain polyolefin oxidation products having very different compositions and correspondingly different properties. For example, products having acid numbers of of from about 15 to 60 mg KOH/g and hydrolysis numbers of from about 30 to 100 can be prepared. Despite the diversity of the reactions taking place during the oxidation, identical conditions and identical starting materials will reproducibly give marketable oxidation products having relatively narrow specification ranges.

An important contribution to the properties, in particular to the performance characteristics important for the textile sector, for example the emulsifiability, is made by the carboxyl groups and the ester groups of the oxidation products, which also account for the predominant proportion of the substituents R². Thus, in the components A of the formula I, R¹ is preferably hydrogen and R² is preferably —COOH and ester groups.

A detailed description of the polyolefin oxidation products, and their properties, composition and preparation is to be found, for example in “Encyclopedia of Polymer Science and Technology”, Volume 6, page 449 et seq. or in “Ullmann's Encyclopedia of Industrial Chemistry”, Volume A28, page 155 et seq., and in the primary publications cited therein, for example in the papers by Grafmüller and Husemann “Über die Oxydation von Polyolefinen”, Makromol. Chem. 40 (1960), 161-188.

Aminofunctional polyorganosiloxanes of the above formula II,

where R³ are identical or different or alkoxy groups of 1 to 4 carbon atoms,

R⁴ is hydroxyl or an R³ radical,

Z is an aminoalkyl radical,

n is from ˜50 to ˜300 and m is from 1 to 4,

are used as component B.

R³ is preferably, methyl, ethyl, methoxy or ethoxy, in particular methyl.

R⁴ is preferably hydroxyl or methyl.

n is preferably chosen so that the polyorganosiloxane of the formula II has a viscosity—measured according to Brookfield—of from 150 to 400, preferably from 180 to 300, mPa.s if R⁴ is methyl and a viscosity of from 2 000 to 10 000, preferably from 3 000 to 8 000, mPa.s, measured at 25 ° C., if R⁴ is hydroxyl or alkoxy.

The alkylene group of the aminoalkyl radical Z is a bridge member L between the silicon atom and the amino group. The alkylene bridge L is of 1 to 10, preferably 1 to 5, carbon atoms; it may be linear or branched and the carbon chain may be interrupted by a hetero member, e.g. —O—, —S— or —NR¹⁵—, where R¹⁵ of the —NR¹⁵— group is hydrogen or C₁— or C₂-alkyl, preferably hydrogen.

Examples of suitable bridge members L are —CH₂—, —C₂H₄—, —CH(CH₃)CH₂—, —(CH₂)₃—, —(CH₂)₆—, —CH₂CH(CH₃)CH₂—, —(CH₂)₁₀—, —CH₂CH₂SCH₂CH₂—, —CH₂CH₂OCH₂CH₂—, —OCH₂CH₂—, —O(CH₂)₃— or —CH₂CH₂NHCH₂CH₂—.

The amino group of the aminoalkyl radical Z corresponds to the formula —NR¹⁶R¹⁷, where R¹⁶ and R¹⁷, independently of one another, are hydrogen or C₁— to C₄-alkyl radicals.

Examples of preferred aminoalkyl radicals are —C₃H₆—NH₂, —C₃H₆—NH—C₂H₄—NH₂, —CH₂—N(CH₃)₂ and —(CH₂)₅—NH₂.

m is chosen so that the polyorganosiloxane has an amine number of from 0.1 to 0.4. (The amine number is understood as meaning the number of ml of 1 N HCl which are required for neutralizing 1 g of the substance to be tested.)

Polyorganosiloxanes of the formula XI which are suitable as component D for the novel polymer emulsions are industrially produced and traded by several companies.

Preferred nonionic emulsifiers which are contained as components C in the novel polymer emulsions are, for example, C₁₀/C₁₋₃-alkanols, alkoxylated with from 3 to 15, preferably from 3 to 10, alkylene oxide units or tallow fatty alcohols (=natural C₁₆/C₁₋₈-alcohols) alkoxylated with from 3 to 150, preferably from 3 to 80, alkylene oxide units.

The alkylene oxide units contained in these components are of 2 to 4, preferably 2 or 3, in particular 2, carbon atoms.

Preferred components D are condensates of fatty acids of the formula III in which R⁵ is branched and especially linear C₁₁— to C₁₋₉-alkyl or alkenyl and in particular C₁₃— to C₁₋₇-alkyl or alkenyl.

The group R⁵—CO— of the fatty acids of the formula III is derived, for example, from lauric acid, myristic acid, elaidic acid, linoleic acid, linolenic acid or arachidic acid. Particularly preferred condensates D are those in which the group R⁵—CO— is derived from stearic acid, palmitic acid, oleic acid, tallow fatty acid or coconut fatty acid.

If naturally occurring fatty acids are used, they can in many cases be mixtures of homologs and/or mixtures of saturated and unsaturated ones having the same number of carbon atoms.

In the context of this invention, tallow fatty acid and coconut fatty acid are thus both the mixtures of the fatty acids occurring in the natural fats, in the ratios present in the fats, and individual fractions or individual compounds isolatable therefrom. The mixtures of the fatty acids present in the natural fats, in the ratios present in the fats, are preferred.

Alkylene groups A¹ and A² in the amino alcohols of the formula II are, for example, 1,1-ethylene, 1,2-ethylene, 1,1-propylene, 1,2-propylene, 1,3-propylene, and 1,2-, 1,3-, 1,4- and 2,3-butylene. A¹ and A² are preferably 1,2-ethylene.

Also preferred for the preparation of the novel polymer emulsions are condensates D which are obtained using an amino alcohol of the formula IVa

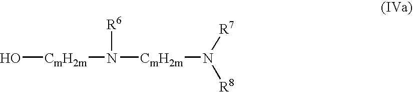

where

R⁶, R⁷ and R⁸ are identical or different and are each hydrogen, methyl or ethyl and m is 2 or 3.

A particularly preferred amino alcohol of the formula IVa is N-(β-aminoethyl)-ethanolamine.

The amino alcohols of the formulae IV and IVa may contain—especially when technical-grade qualities are used—certain proportions of mono-, di- or trialkanolamines of the formula [HO-A¹ (or A²)]ₓ—NH(₃₋ₓ), where x is 1, 2 or 3. These proportions should be less than 20, preferably less than 10, % by weight.

Furthermore preferred for the preparation of the novel polymer emulsions are condensates D which are obtained using a

polyol of the formula Va,

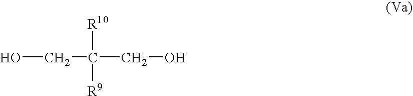

where

R⁹ is hydroxyl or hydroxymethyl and

R¹⁰ is hydrogen, methyl or ethyl or hydroxymethyl.

Examples of preferred polyols of the formula V or Va are glycerol (R⁹=OH, R¹⁰=H), 1,1,1-trimethylolethane and 1,1,1-trimethylolpropane (R⁹=CH₂OH, R¹⁰=CH₃ or C₂H₅) and pentaerythritol (R⁹=R¹⁰=CH₂OH).

For the preparation of the condensates D, the fatty acids of the formula III are heated with the amino alcohols IV and the polyols V in the abovementioned molar ratios in the presence of an acidic catalyst, preferably in the presence of catalytic amounts of phosphorous acid and/or hypophosphorous acid. The condensation is expediently carried out at from 150 to 170° C. It is furthermore expedient to distill off the water of reaction continuously. The condensation can also be carried out in the presence of a solvent or diluent. For example, the use of an entraining agent which forms an aceotropic mixture with water, considerably facilitating the removal of the water from the reaction mixture, and working under an inert gas, for example under nitrogen, are advantageous.

Preferably, fatty acids of the formula III are condensed with the amino alcohols of the formula IV and the polyols of the formula V in a ratio such that the condensates D contain fatty acid alkanolamine esters of the formula VIII

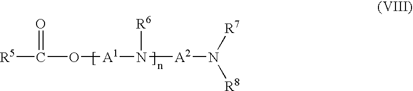

and fatty acid hydroxyalkyl esters of the formula IX

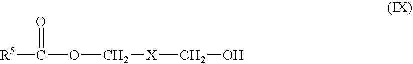

in a molar VIII: IX ratio of from 5:95 to 95:5

and optionally unesterified amino alcohols of the formula IV and unesterified polyols of the formula V, the substituents R⁵ to R⁸, A¹, A² and X specified in the formulae VIII and IX and the substituents R⁹ and R¹⁰ included in their definition having the abovementioned meanings.

Particularly preferred components D are those which contain fatty acid alkanolamine esters of the formula VIIIa

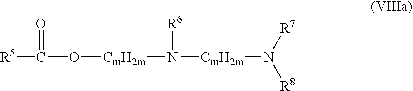

and fatty acid hydroxyalkyl esters of the formula IXa

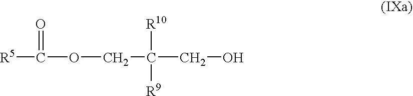

in a molar VIIIa: IXa ratio of from 5:95 to 95:5 and

optionally unesterified amino alcohols of the formula IVa and unesterified polyols of the formula Va, the substituents R⁵ to R¹⁰ and m specified in the formulae VIIIa and IXa having the abovementioned meanings.

It may be advantageous if the amino alcohols and polyols of the formulae IV and V are condensed with the fatty acid component of the formula III in a stoichiometric excess, and unconverted residual amounts of IV and V are therefore also present in the resulting condensate. These admixtures are not troublesome and may even be desirable. Suitable components D are therefore condensates of fatty acids of the formula III with from 40 to 70 mol %, per mole of fatty acid, of amino alcohols of the formula IV and from 30 to 120 mol %, per mole of fatty acid, of polyols of the formula V.

Preferred constituents of the novel polymer emulsions are in particular also those components D which contain from 0 to 50 mol %, per mole of fatty acid alkanolamine ester, of alkanolamines of the formula IV, preferably of the formula IVa, and from 0 to 100 mol %, per mole of fatty acid polyol ester, of polyols of the formula V, preferably of the formula Va.

The aminoesters contained in the component D may be present in free form or in the form of their salts, preferably as formates or acetates, in the novel polymer emulsions.

Preferred components E of the novel polymer emulsions are at least partially quaternized condensates of fatty acids of the formula VI indicated above with from 0.5 to 2.0, in particular from 0.85 to 1.5, mol of tertiary amino alcohols of the formula VII per mole of fatty acid.

The condensates E are quaternized with quaternizing agents of the formula X-R¹², where R¹² is a lower alkyl radical of 1 to 4 carbon atoms and the radical X which can be eliminated as an anion is as a rule a halogen atom, a methosulfate or sulfate group or a sulfonate group, preferably the methosulfate group.

The partially quaternized condensate consists of a mixture of compounds of the formulae X and XI,

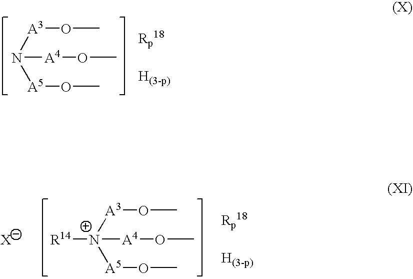

where A³, A⁴ and A⁵ have the abovementioned meanings,

R¹⁸ is a radical of the formula —CO—R¹¹, X is one of the abovementioned anions and p is 0, 1, 2 or 3.

The proportions of the components contained in said mixture depend on the one hand on the molar ratio in which fatty acids of the formula VI have been condensed with amines of the formula VII and the molar ratio in which the esterified amines of the formula X have been reacted with the quaternizing agent and, on the other hand, on the reaction conditions under which the condensation has been carried out. The composition may therefore be varied entirely as desired by a person skilled in the art within the definition limits specified above in the formulae, by a suitable choice of the molar ratios and of the reaction conditions.

If, for example, a mixture which substantially comprises compounds in which p is 3 is desired, the fatty acid is then reacted with the amine of the formula VII close to the lower limit of the abovementioned reaction range (e.g. fatty acid:amine=1:0.35). Conversely, mixtures which contain a high proportion of compounds with p=0 can be prepared by using the amine of the formula VII in the condensation in excess, i.e. at the upper limit of the stated molar ratio range. Mixtures in which on average, for example, one or two of the OH groups of the amine of the formula VII have been esterified with the fatty acid, a person skilled in the art will choose a molar ratio of fatty acid to amine of 1:1 or of 1:2. Such a mixture contains, as a rule, compounds of the formula X in which p has values of 0, 1, 2 and 3. However, the proportions of these components in the mixture are very different, the highest proportion being accounted for as a rule by the compound whose composition is closest to the average composition. For example, a condensate of 1 mol of fatty acid of the formula VI with one mole of amine of the formula VII contains a predominant proportion of monoester (p=1) but also unesterified amine (p=0) and diester (p=2). Even small amounts of the triester (p=3) may occur.

The range of the proportions depends on the one hand on the natural reactivities of the reactants but can be routinely controlled by a person skilled in the art within certain limits by the choice of the reaction conditions, in particular the condensation temperature and the reaction time.

Particularly preferred mixtures of condensates of the formula X are those which are obtained in a condensation which was continued until an acid number of from 15 to 30, preferably from 15 to 25, mg KOH/g was reached or in which it was possible to establish the natural equilibrium.

Expediently, both the excess amounts of the amino alcohols of the formula VII contained in the components E and the esters of the formula X are at least partially quaternized. Preferably at least 60, especially 85, in particular 95, % of all amino groups contained in the components B are quaternized. The amount of quaternizing agent is therefore based on the starting material of the formula VII.

The novel polymer emulsions have an optimum combination of different performance characteristics. Products having such an advantageous property profile have to our knowledge not been commercially available to date.

The novel polymer emulsions impart a very pleasant, soft, somewhat smooth, silk-like hand to the treated textiles.

The stability of the novel polymer emulsions is excellent. The size of the emulsified droplets is in the semimicro range, i.e. they have an average diameter of from 15 to 20 nm, with the result that the aqueous dilutions of the polymer emulsions are transparent, almost like true aqueous solutions.

The novel polymer emulsions have a very good shelf-life. They remain unchanged even after one month at 60° C.

Furthermore, they have a very low viscosity and very good flow behavior so that, in spite of their relatively high active ingredient concentration of from 20 to 30% by weight, they are readily pumpable and meterable.

The novel polymer emulsions are stable in all pH ranges, even in the strongly acidic range. They can therefore also be used in the moist crosslinking process, which operates in the strongly acidic pH range.

Surprisingly, the novel polymer emulsions, in spite of the very different ionogenicities and consistencies of the components contained therein, are extremely stable even in the presence of added electrolytes; they therefore have a hidden nonionic character. This results in the further considerable application advantage that they are compatible with all additives which are concomitantly used in the permanent finishing of textile materials.

The novel polymer emulsions do not yellow on the white material at the condensation temperatures of up to 180° C. customary in permanent finishing.

A further advantage is that they can be prepared in low-foam form so that they are also suitable for exhaust processes in apparatuses having strong circulation currents, e.g. in JET apparatuses.

It is also very surprising that the novel polymer emulsions not only are themselves extremely stable but also substantially inhibit the deposition of condensates of the resin precondensates used as permanent finishing agents on bowls and trough walls of the machines used. They can therefore be particularly advantageously used as assistants in the permanent finishing of textile materials.

The present invention therefore also relates to the use of the novel polymer emulsions alone or in combination with other additives and in particular with permanent finishing agents for textile treatment.

Textile materials for the purposes of this description are natural or synthetic fiber materials which in principle may be present in all processing steps. For reasons of expediency, however, sheet-like textile materials and made-up goods are preferably treated using the novel polymer emulsions.

The preparation of the novel polymer emulsions can be carried out in principle by a person skilled in the art in a manner known per se using conventional mixing apparatuses. Since the components A to E contained in the novel polymer emulsions have different ionogenicity and consistency, it has proven advantageous to carry out the mixing of the components in a specific order and within specific temperature ranges in order to achieve an optimum “product harmony”.

The following preparation process, which is likewise a subject of this invention, is therefore advantageously used:

1) First, a melt is prepared from one or more compounds of component classes A (for example ®LUWACHS OA2 from BASF AG) and C (for example mixtures of tallow fatty alcohol with 6.5 EO, tallow fatty alcohol with 80 EO and C₁₃/C₁₅-alcohols with 11 EO in a mixing ratio of from 2:1:1 to 0.5:1:1) at from 100 to 150° C., preferably from 120 to 140° C., for example at 130° C.

2) Solutions of one or more compounds of component classes D and E, with or without the addition of emulsifier components C (e.g. a C₁₀/C₁₃-alcohol, ethoxylated with 7 EO units), in water are then prepared. Exemplary amounts of the compounds to be used are shown in table 1 below.

3) Subsequently, the melt prepared under 1) is incorporated at from 85 to 100° C., for example at 98° C., into the aqueous component solution prepared under 2) and the mixture obtained is finely dispersed using a powerful mixing apparatus, for example by means of double jet mixing at 120 bar. One or more compounds of component class B are then added and the emulsion is finally homogenized again at room temperature, for example once again by means of jet mixing at 120 bar.

This process can also be carried out using the components B and D in the form of prepared emulsions. This measure considerably facilitates the preparation of homogeneous novel polymer emulsions.

The examples which follow illustrate the present invention.

The components D1, D2 and E used in the examples are prepared as follows:

Preparation of Component D1

55 g of glycerol (99% by weight pure) and 217 g of technical grade stearic acid (stearic acid/palmitic acid=70% by weight/30% by weight, molecular weight 284) are melted at from 80 to 90° C. in a glass flask equipped with a nitrogen flow-through system and a water estimator. 42 g of N-(β-aminoethyl)ethanolamine and 0.65 g of 50% strength H₃PO₃ are then added while stirring.

The molar ratio of fatty acid to aminoethanolamine to trimethylolpropane is 1.9:1:1.5. The amount of catalyst is 0.3% by weight, based on the amount of the fatty acid used.

The flask is flushed with nitrogen and, as soon as the air has been displaced, the clear, yellowish reactant mixture is heated to 160° C. while maintaining a slow nitrogen stream with constant stirring, and stirring is continued at this temperature for 4.5 hours. During this time, the water formed in the reaction is continuously removed (distilled off).

After the reaction time has ended, the acid number (measured potentiometrically) has a value of 19 mg KOH/g, corresponding to a conversion of about 92% (based on fatty acid). The liquid waxy reaction product obtained is cooled to 80 to 90° C. and is neutralized by adding 26 g of acetic acid.

Preparation of Component D2

54 g of 1,1,1-trimethylolpropane and 217 g of technical-grade stearic acid (stearic acid/palmitic acid=70% by weight/30% by weight, molecular weight 284) are melted at from 80 to 90° C. in a glass flask equipped with a nitrogen flow-through system and a water estimator. 42 g of N-(β-aminoethyl)ethanolamine and 0.65 g of 50% strength H₃PO₃ are then added while stirring.

The molar ratio of fatty acid to aminoethanolamine to trimethylolpropane is 1.9:1:1. The amount of catalyst is about 0.3% by weight, based on the amount of the fatty acid used.

The flask is flushed with nitrogen and, as soon as the air has been displaced, the clear, yellowish reactant mixture is heated to 160° C. while maintaining a slow nitrogen stream with constant stirring, and stirring is continued at this temperature for 4.5 hours. During this time, the water formed in the reaction is continuously removed (distilled off).

After the end of the reaction time, the acid number (measured potentiometrically) has a value of 20 mg KOH/g, corresponding to a conversion of about 90% (based on fatty acid). The liquid waxy reaction product obtained is cooled to 80 to 90° C. and is neutralized by adding 26 g of acetic acid.

Preparation of Emulsions of the Components D1 and D2.

80 g of water at about 80° C. are initially taken in a stirred vessel, 20 g of one of the condensates D1 or D2 obtained above are added in the form of a melt and the mixture is left to cool to room temperature while stirring. A 20% strength by weight low-viscosity emulsion is obtained.

Preparation of Component E

51.45 g of technical-grade stearic acid (stearic acid/palmitic acid=70% by weight/30% by weight, molecular weight 284) are melted at from 80 to 90° C. in a glass flask equipped with a nitrogen flow-through system and a water estimator. 28.36 of triethanolamine and 0.16 g of 50% strength H₃PO₃ are then added while stirring.

The molar ratio of fatty acid to aminoethanolamine to trimethylolpropane is 1:1.02. The amount of catalyst is about 0.3% by weight, based on the amount of the fatty acid used.

The flask is flushed with nitrogen and, as soon as the air has been displaced, the clear, yellowish reactant mixture is heated to 160° C. while maintaining a slow nitrogen stream with constant stirring, and stirring is continued at this temperature for 5 hours. During this time, the water formed in the reaction is continuously removed.

After the end of the reaction time, the acid number (measured potentiometrically) has a value of 20 mg KOH/g, corresponding to a conversion of about 90% (based on fatty acid). The liquid waxy reaction product obtained is cooled to 70 to 80° C., and 14.54 g of dimethyl sulfate are added dropwise at this temperature in the course of about 30 minutes. The mixture is stirred for a further hour at 80° C. and then cooled to room temperature.

Component A used in the examples is a polyethylene wax oxidized with air (e.g. commercial product ®LUWACHS OA 2), which has the following parameters:

Molar mass: 3 000 g/mol,

Ubbelohde drop point: from 107 to 113 ° C.,

melting point according to DIN 51007: from 99 to 108° C.

density: 0.96 g/cm3,

acid number: from 20 to 25 mg KOH/g.

Preparation of an Aqueous Emulsion of an Amino-Functional Polyorganosiloxane (Component B)

A) Emulsifier Solution:

7.0 g of a C₁₀-alkanol ethoxylated with 7 EO

1.3 g of a C₁₀-alkanol ethoxylated with 3 EO

1.8 g of tallow fatty alcohol, ethoxylated with 30 EO, and

0.12 g of acetic acid

are dissolved in 59.78 g of water.

B) 30.0 g of a dimethylpolysiloxane which has a silicon-bonded OH group in each of the terminal groups, a Brookfield viscosity, measured at 25° C., of about 8 000 mPa.s and an amine number of 0.12 (e.g. commercial product ®Wacker Finish WR1200) are slowly added to this emulsifier solution with vigorous stirring.

The mixture is then stirred vigorously for a further hour.

The 30% strength by weight emulsion thus obtained is used as component B in the examples indicated below.

Preparation of the Novel Polymer Emulsions.

All amounts stated in the tables are calculated relative to solid substance.

1) First, for the preparation of the melts S1 to S5, the components A and C are mixed with one another in the amounts shown in table 1 and melted at 130° C.

TABLE 1
Composition of the melts S1 to S5 in parts by weight
(pbw) of the components.

| | | | | | S5 |
|---|---|---|---|---|---|
| Component | S1 [pbw] | S2 [pbw] | S3 [pbw.] | S4 [pbw] | [pbw] |
| Component A | 4.0 | 3.0 | 4.0 | 7.7 | 3.0 |
| Component C1 | 1.5 | 1.5 | 4.0 | 1.5 | 1.5 |
| Component C2 | 2.1 | 2.1 | 2.1 | 2.1 | 2.1 |
| Component C3 | 2.1 | 2.1 | 2.1 | 2.1 | 2.1 |

Tallow fatty alcohol, ethoxylated with 6.5 EO units, is used as component C1.

Tallow fatty alcohol, ethoxylated with 80 EO units, is used as component C2.

C₁₀/C₁₃-alcohol, ethoxylated with 11 EO units, is used as component C3.

2) Aqueous solutions L1 to L5 of the components D1, D2 and E and, if required, an antifoam are then prepared with the compositions stated in table 2. For this purpose, the stated amounts of the components and, if required, an antifoam are stirred in succession at 98° C. into the stated amount of water and stirring is continued until homogenization is complete.

TABLE 2
Composition of the aqueous solutions L1 to L5 in parts
by weight (pbw) of the components.

| | | | | | L5 |
|---|---|---|---|---|---|
| Component | L1 [pbw] | L2 [pbw] | L3 [pbw] | L4 [pbw] | [pbw] |
| Condensation | 68.2 | 69.2 | 65.7 | 55.3 | 69.5 |
| water | | | | | |
| Component E | 5.3 | 5.3 | 5.3 | 5.3 | 5.3 |
| Component D1 | 4.2 | 4.2 | 4.2 | 4.2 | 4.2 |
| Component D2 | 1.8 | 1.8 | 1.8 | 1.8 | 1.8 |
| ASM SRE* | 0.8 | 0.8 | — | 0.5 | — |

*(Antifoam SRE from Wacker AG, Burghausen)

3) The melts S1 to S5 are stirred into the prepared hot solutions L1 to L5 at 98° C., in each case the melts and solutions bearing the same numerals being combined (i.e. melt S1+solution L1, melt S2+solution L2, etc.). The mixtures obtained are cooled to 25° C. and then homogenized twice at 120 bar in a laboratory homogenizer (e.g. Alfa Laval SHL 05 from Gaullien).

10 parts by weight (containing 3 parts by weight of solid substance) of the abovementioned emulsion of component B are stirred into each of the emulsions SL1 to SL3 thus prepared, and 20 parts by weight (containing 6 parts by weight of solid substance) of the abovementioned emulsion of component B are stirred into the emulsion SL4.

There is no addition of component B to the emulsion SL5.

All emulsions SL1 to SL5 are then again homogenized at 120 bar in the homogenizer.

Testing of Performance Characteristics of the Novel Emulsions SL1 to SL5.

Testing of the Shelf-Life.

Samples of the emulsions SL1 to SL5 were stored for one month in a drying oven at 60° C.

Result:

The emulsions SL1 to SL4 had unchanged homogeneity after storage.

The emulsion SL5 had separated after a storage time of only 6 hours.

Testing of Shear Stability.

The shear stability test was carried out with the novel emulsions SL1 to SL4. The emulsion SL5 was not subjected to this test owing to the poor shelf life.

For carrying out the test, 6 aqueous experimental liquors V1 to V6 having the composition stated in table 3 were prepared. For this purpose, the amounts of the liquor constituents stated in table 3 were stirred into from about 700 to 800 ml of water and the mixture was then made up to 11.

TABLE 3
Composition in g/l of the experimental liquors for testing
the shear stability.

| | Liquor V1 | Liquor V2 | Liquor V3 | Liquor V4 | Liquor V5 | Liquor V6 |
|---|---|---|---|---|---|---|
| Liquor constituent | [g/l] | [g/l] | [g/l] | [g/l] | [g/l] | [g/,l] |
| 60% strength by weight | 50 | 50 | 50 | 50 | 50 | 50 |
| solution of | | | | | | |
| N,N′-dimethoxymethyl- | | | | | | |
| 4,5-dihydroxyethyleneurea | | | | | | |
| MgCl₂ · 6H₂O | 10 | 10 | 10 | 10 | 10 | 10 |
| Emulsion SL1 | 30 | — | — | — | — | — |
| Emulsion SL2 | — | 30 | — | — | — | — |
| Emulsion SL3 | — | — | 30 | — | — | — |
| Emulsion SL4 | — | — | — | 30 | — | — |
| Component D | — | — | — | — | 30 | — |

The experimental liquors V1 to V5 were first stirred for 10 minutes at 3 000 rpm and then tested as follows:

450 ml of the liquor to be tested are introduced into the box of a pad-mangle. The pad-mangle has two horizontally mounted bowls 9 cm in diameter and 15 cm in length. The electric drive is transmitted via an infinitely variable gear. The nip pressure is adjusted by means of a 35 cm long lever arm which is loaded at the end with a lead weight of about 12 kg. The Shore hardness of the pad-mangle bowls is 72° for the driving bowl and 84° for the counterpressure bowl.

An endless cotton fabric 12 cm in width and 56 cm in length is passed through the liquor and upward into the nip at about 12 m/min for 30 minutes. Any film formed on the bowl is then rated by visual inspection where 1 denotes no bowl film and 5 a pronounced bowl film.

Result:

The experimental liquor V6 (without addition of the novel polymer emulsion) produces no bowl film (rating 1)

The experimental liquors V1 to V3 (containing the emulsions SL1, SL2 and SL3) produce no bowl film. The bowl surface remains smooth and clean (rating 1).

The liquor V4 (containing the emulsion SL4) produces a visually scarcely susceptible bowl film (rating 1-2) and the liquor V5 (containing only the component D) produces a distinctly detectable bowl film (rating 2-3).

Testing of Softness (Fabric Hand).

A 50/50 polyester/cotton blend fabric having a basis weight of about 90 g/m² is impregnated with the experimental liquors V1 to V6 and squeezed off on the pad-mangle to a wet pickup of about 70% by weight, based on the weight of the dry fabric. The moist fabric is then dried at 110 ° C. and cured at 140 ° C. for 4 minutes.

Result:

The fabric samples treated with the liquors V1, V2, V3 and V5 show no differences in hand; they feel equally soft with characteristic silicone-specific smoothness.

The fabric finished with the liquor V4 corresponds to the fabric samples finished with the liquors V1 to V3 and V5 with regard to softness, but is a shade superior to them with regard to smoothness.

On the other hand, the fabric finished with the liquor V6 feels hard and rough.

Testing of Sewability

A cotton knit was finished as described in the testing of fabric hand. The finished material was stitched on an industrial sewing machine using a 5620 SES needle system and a No. 120 thread at a speed of 4 500 min-1 and 6 stitches per cm.

The total stitches and damaged stitches were then counted and converted into the number of defects per 1 000 stitches.

Result:

| Finished with liquor | V1 | V2 | V3 | V4 | V5 | V6 |
|---|---|---|---|---|---|---|
| Damaged stitches per | 32 | 35 | 32 | 16 | 28 | >100 |
| 1,000 stitches | | | | | | |

We claim:

1. A stable aqueous polymer emulsion comprising the components A to C, water and, if required, further assistants and additives,
component A comprising
polyolefin oxidation products comprising identical or different groups of the formula I 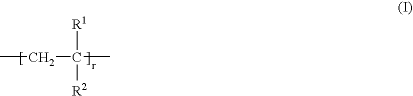
where
R¹ is hydrogen or lower alkyl,
R is hydrogen, —COOH or another, oxygen-containing functional group and
R² is furthermore a short- or medium-chain alkyl or alkenyl group or cyclohexyl group which may also be substituted by —COOH or another, oxygen-containing functional group, or
R¹ and R² together are oxygen and r is from 30 to 200,
component B comprising
aminofunctional polyorganosiloxanes of the formula II, 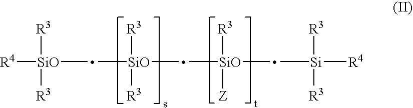
where R³ are identical or different lower alkyl or lower alkoxy groups,
R⁴ is hydroxyl or an R³ radical
Z is an aminoalkyl radical,
S is from ˜50 to ˜300 and t is from 1 to 4, and
component C comprising
nonionic emulsifiers consisting of mixtures of alkoxylated higher alkanols.

2. A stable aqueous polymer emulsion as claimed in claim 1, which additionally contains the components D and E,
component D comprising
condensates of fatty acids of the formula III 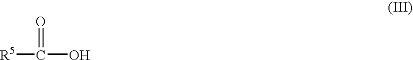
where R⁵ is a medium- to long-chain alkyl or alkenyl radical,
with from 5 to 150 mol %, per mole of fatty acid, of amino alcohols of the formula IV 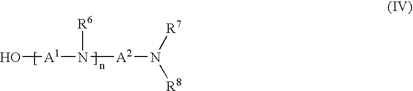
where
A¹ and A² are lower alkylene groups,
R⁶, R⁷ and R⁸ are identical or different and are each hydrogen, lower alkyl or a group
-A¹-OH or -A²-OH and
n is an integer from 1 to 5,
and with from 5 to 200 mol %, per mole of fatty acid, of polyols of the formula V
HO—CH₂—Y—CH₂—OH (V)
where Y is a chemical bond or a group —CR9R¹⁰—, where
R⁹ is hydrogen, lower alkyl or a further hydroxy-lower alkyl group and
R¹⁰ is hydrogen, lower alkyl or a further hydroxy-lower alkyl group,
and component E comprising
at least partially quaternized condensates of fatty acids of the formula VI 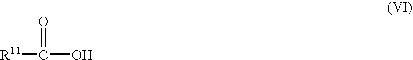
where R¹ is a medium- to long-chain alkyl or alkenyl radical,
with from 0.35 to 2.0 mol, per mole of fatty acid, of tertiary amino alcohols of the formula VII 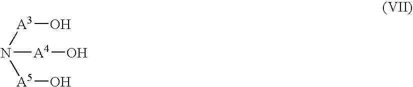
where
A³, A⁴ and A⁵ are lower alkylene groups, quaternized with quaternizing agents of the formula X-R¹², where X is a radical which can be eliminated as an anion and R¹² is a lower alkyl radical.

3. A stable aqueous polymer emulsion as claimed in either of claims 1 and 2, which contains, as component A, polyolefin oxidation products comprising identical or different groups of the formula I 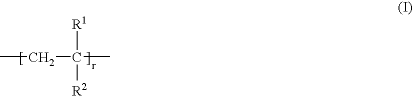
where
R¹ is hydrogen or C₁- to C₄-alkyl,
R² is hydrogen, —COOH, —CHO, —OH, lower alkylcarbonyloxy (—O—CO—R 3) or lower alkoxycarbonyl (—COOR¹⁴), where R¹³ and R¹⁴ are alkyl radicals, preferably of 1 to 4 carbon atoms, and
R² is furthermore a C₁- to C₆-alkyl or alkenyl group or cyclohexyl group which may furthermore be substituted by —COOH, —CHO, —OH, lower alkylcarbonyloxy (—O—CO—R¹³) or lower alkoxycarbonyl (—COOR¹⁴), where R¹³ and R¹⁴ are alkyl radicals, preferably of 1 to 4 carbon atoms, it being possible for —COOH and —OH groups R² or —COOH and —OH groups contained in substituents R² to form intermolecular or intramolecular esters with one another, or
R¹ and R² together are oxygen,
r is from 30 to 200 and
the polyolefin oxidation product has an acid number of from 10 to
60 mg KOH/g according to DIN 53402.

4. A stable aqueous polymer emulsion as claimed in any of claims 1 to 3, which contains, as component B, aminofunctional polyorganosiloxanes of the formula II, 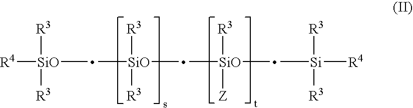
where
R³ is methyl, ethyl, methoxy or ethoxy,
R⁴ is hydroxyl or methyl,
n is chosen so that the polyorganosiloxane of the formula II has a Brookfield viscosity of from 150 to 400 mPa.s if R⁴ is methyl and a viscosity of from 2 000 to 10 000 mPa.s mPa.s if R⁴ is hydroxyl or alkoxy.

5. A stable aqueous polymer emulsion as claimed in any of claims 1 to 4, which contains, as component D, condensates of fatty acids of the formula III 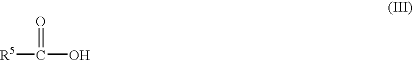
where R⁵ is a C₉- to C₂₁-alkyl or alkenyl radical,
with from 5 to 150 mol %, per mole of fatty acid, of amino alcohols of the formula IV 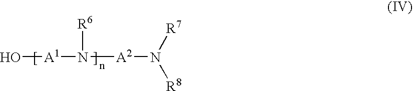
where
A¹ and A² are C₂- to C₄-alkylene groups,
R⁶ R and R⁸ are identical or different and are each hydrogen, C₁- to C₄-alkyl or a group
-A¹-OH or -A²-OH and
n is an integer from 1 to 5,
and with from 5 to 200 mol %, per mole of fatty acid, of polyols of the formula V
HO—CH₂—Y—CH₂—OH (V)
where Y is a chemical bond or a group —CR⁹R¹⁰—,
where R⁹ is hydrogen, C₁- to C₄-alkyl or a further hydroxyalkyl group of 1 to 4 carbon atoms and
R¹⁰ is hydrogen, C₁- to C₄-alkyl or a further hydroxyalkyl group of 1 to 4 carbon atoms.

6. A stable aqueous polymer emulsion as claimed in any of claims 1 to 5, which contains, as component E,
at least partially quaternized condensates of fatty acids of the formula VI 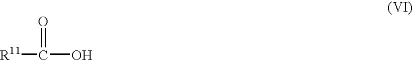
where R¹¹ is a C₉- to C₂₁-alkyl or alkenyl radical,
with from 0.35 to 2 mol, per mole of fatty acid, of tertiary amino alcohols of the formula VII 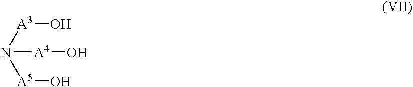
where
A³, A⁴ and A⁵ are C₂- to C₄-alkylene groups, preferably ethylene groups, quaternized with quaternizing agents of the formula X-R¹², where X is a radical which can be eliminated as an anion and R¹² is a lower alkyl radical of 1 to 4 carbon atoms.

7. A stable aqueous polymer emulsion as claimed in any of claims 1 to 6, which contains
from 1 to 15, in particular from 2 to 10, % by weight of components A,
from 1 to 15, in particular from 2 to 10, % by weight of components B,
from 4 to 10, in particular from 5 to 8, % by weight of components C,
from 2 to 10, in particular from 4 to 8, % by weight of components D,
from 2 to 10, in particular from 4 to 8, % by weight of components E and water and further assistants to 100% by weight.

8. A stable aqueous polymer emulsion as claimed in any of claims 1 to 7, wherein the condensates used as component D contain fatty acid alkanolamine esters of the formula VIII
and fatty acid hydroxyalkyl esters of the formula IX
in a molar IV:V ratio of from 5:95 to 95:5 and optionally unesterified amino alcohols of the formula IV and unesterified polyols of the formula V.

9. A process for the preparation of a stable aqueous polymer emulsion of claim 1, wherein
1. first, a melt is prepared from one or more compounds of component classes A and C at from 100 to 150° C.,
2. solutions of one or more compounds of component classes D and E, with or without addition of emulsifier components C, in water are then prepared,
3. subsequently, at from 85 to 100° C., the melt prepared in the first step is incorporated and finely dispersed in the aqueous component solution prepared in the second step and
4. one or more compounds of component class B are then added and the emulsion is finally homogenized again at room temperature.

10. The use of a stable aqueous polymer emulsion of claim 1 alone or in combination with other additives and in particular with permanent finishing agents for textile treatment.
